(19) United States
(12) Patent Application Publication
(10) Pub. No.: US 2002/0009411 A1
(43) Pub. Date: Jan. 24, 2002

(54) Method for producing tungsten carbide

(76) Inventors: Gordon L. Zucker, Carefree, AZ (US); Jerome P. Downey, Parker, CO (US); David A. Bahr, Denver, CO (US); Frank M. Stephens JR., Lakewood, CO (US); John P. Hager, Goldon, CO (US)

Correspondence Address: MARSH FISCHMANN & BREYFOGLE LLP, Suite 411, 3151 S. Vaughn Way, Aurora, CO, 80014, US

(21) Appl. No.: 09/779,193

(22) Filed: Feb. 7, 2001

Related U.S. Application Data
(60) Provisional application No. 60/181,107, filed on Feb. 8, 2000.

(51) Int. Cl. C01B 31/34

(52) U.S. Cl. 423/440

(57) ABSTRACT

A method for the production of fine-grain tungsten carbide (WC) powder comprising heating a tungsten precursor compound in contact with a gas mixture including a hydrocarbon such as methane (CH₄). The method is preferably a one-step continuous method wherein the heating rate and reaction temperature is well controlled for the economical production of high quality tungsten carbide powder. The tungsten carbide powder advantageously has a high purity and a small crystallite size and can be used in the manufacture of products such as cutting tools having high wear resistance.

This application claims priority from U.S. Provisional Patent Application No. 60/181,107, filed on Feb. 8, 2000.

### BACKGROUND OF THE INVENTION

1. Field of the Invention

The present invention relates to a method for producing fine-grain tungsten carbide powder product from a tungsten precursor compound in a reactor, such as a rotary kiln. The tungsten carbide powder product can advantageously be used, for example, in cutting tools.

2. Description of Related Art

Fine-grain tungsten carbide is useful for cutting tools and other applications requiring wear resistance and chemical stability. For such applications, the tungsten carbide powder is typically cemented with a binder phase (e.g., a ductile metal) and formed into the article. The preferred form of tungsten carbide for such applications is monotungsten carbide (WC). Other forms of tungsten carbide exist, such as ditungsten carbide (W₂C), however WC is preferred for high temperature and wear resistant applications.

Different methods for producing tungsten carbide have been disclosed in the prior art. U.S. Pat. No. 4,008,090 by Miyake et al. discloses a two-step process for converting tungsten oxide (WO₃) to WC. It is disclosed that ammonium paratungstate ((NH₄)₆W₁₂O₄₁.6H₂O, or “APT”) can be used as the starting material by first converting the APT to WO₃. The WO₃ is mixed with particulate carbon and is heated to about 1000° C. under a vacuum and the temperature is then increased to about 1400° C. in a hydrogen atmosphere to form WC. It is disclosed that a rotary kiln can be used for the heating steps.

U.S. Pat. No. 4,664,899 by Kimmel et al. discloses a method for making WC powder wherein APT is mixed with solid carbon and reduced at a temperature in excess of 878° C. The heating step produces a mixture of tungsten, W₂C and WC. Additional carbon is then added and the mixture is heated again to about 1200° C. to form WC.

U.S. Pat. No. 5,166,103 by Krstic also discloses a method for making WC powders. The process includes mixing APT and carbon, heating the mixture in a rotary furnace under a reducing atmosphere to 900° C. to 1600° C. and holding the mixture at the reaction temperature for at least 30 minutes to form WC. The use of H₂ and N₂ gases is avoided in the process.

U.S. Pat. No. 5,567,662 by Dunmead et al. discloses a method for making a carbide from an oxide and solid carbon. The oxide and solid carbon are mixed and heated to 1000° C. to 1120° C. in a non-reducing atmosphere. The mixture is then cooled, additional carbon is added and the mixture is heated a second time to 1200° C. to 1300° C. in hydrogen.

Processes that rely upon solid-solid reactions (e.g., between a tungsten-containing material and carbon) have many disadvantages including a slow reaction rate and the need for very high processing temperatures.

Methods using solid-gas reactions to produce tungsten carbide are also known. U.S. Pat. No. 3,077,385 by Robb discloses a method for producing carbides, including tungsten carbides, in a fluidized bed. The process includes reacting hydrogen in a fluidized bed with a tungsten precursor compound and thereafter introducing a carburizing gas into the hydrogen gas phase at a temperature of at least 800° C.

U.S. Pat. No. 4,115,526 by Auborn et al. discloses a process for making reactive tungsten from a tungsten compound such as tungstic acid or APT by heating the compound to 450° C. to 700° C. in a hydrogen atmosphere to form tungsten metal. It is disclosed that the metal can then be carburized in hydrogen (H₂) and methane (CH₄) at about 800° C. to 835° C. to form WC.

U.S. Pat. No. 5,372,797 by Dunmead et al. discloses a method for forming tungsten carbide using solid-gas reactions. A tungsten-containing material is heated in a flowing atmosphere containing 90-99 percent H₂ and 1-10 percent CH₄ to convert the tungsten-containing material to WC. WO₃ is the preferred tungsten-containing material, although it is disclosed that APT can also be used. The heating steps include heating to a first temperature of 520° C. to 550° C. and subsequently heating to 800° C. to 900° C. at a controlled rate and holding the charge for at least about 15 minutes to form WC. Dunmead et al. avoid the use of CO and CO₂ gases in the process.

U.S. Pat. No. 5,919,428 by Gao et al. discloses a method for forming WC particles. It is disclosed that APT is a suitable precursor material for the WC. A precursor is reacted with a gas mixture of hydrogen and a carbon source gas, preferably carbon monoxide (CO). The volume ratio of hydrogen to carbon source gas is from 1:1 to 3:1. The reaction rate is controlled by controlling the rate of heat increase up to about 700° C. where the precursor is held for about 2 to 6 hours. The rate of heat increase is not greater than about 25° C./min. It is disclosed that this permits the formation of WC directly from tungsten without the formation of intermediate elemental tungsten or sub-stoichiometric tungsten carbide. The tungsten carbide powder has an average grain size of about 10 nanometers. However, the three examples disclosed by Gao et al. consisted of materials tested in a thermogravimetric analysis (TGA) device having a sample size of 100 mg and 600 mg. Gao et al. do not address the reaction kinetics that must be considered for producing such materials in large quantities.

It would be advantageous to provide a simple process for the conversion of an inexpensive feed material to fine-grain tungsten carbide powder. It would be particularly advantageous if the conversion rate of tungsten to tungsten carbide was high, such as greater than about 99 percent. It would also be advantageous if such a process were a continuous process.

### SUMMARY OF THE INVENTION

The present invention is directed to a method for the production of fine-grain tungsten carbide. According to one embodiment, tungsten carbide is formed from a tungsten precursor compound by heating in a reactor to a first temperature of at least about 450° C. in a first gas reducing composition to form an intermediate tungsten product. The intermediate tungsten product is then carburized in the reactor by further heating to a second temperature of at least about 750° C. under a carburizing gas composition, which includes at least a first hydrocarbon species such as methane. A preferred tungsten precursor compound is ammonium paratungstate.

The method efficiently converts at least about 98 weight percent, more preferably at least about 99 weight percent and even more preferably at least about 99.5 weight percent of the tungsten in the tungsten precursor compound to tungsten carbide.

According to yet another embodiment of the present invention the method includes heating a tungsten precursor compound in a reactor at an average heating rate of from about 3° C./min to about 9° C./min, such as from about 4 to about 6° C./min, in an atmosphere including methane to a reaction temperature of at least about 750° C. The total treatment time is sufficient to convert at least about 98 weight percent of the tungsten in the tungsten precursor compound to tungsten carbide.

The reactor is preferably a rotary kiln such as a rotary kiln including an elongated tube disposed on horizontal axis wherein the tube is adapted to rotate and move the feed through the elongated tube by virtue of the rotation of the tube and the degree of tilt from the horizontal axis. Adjusting the tilt from the horizontal axis and the rotational speed of the tube can at least partly control the average heating rate and the residence time.

The present invention is also directed to a novel tungsten carbide powder product that includes at least about 99.5 weight percent WC and wherein the average crystallite size of the WC is very small, such as not greater than about 20 nanometers.

### DESCRIPTION OF THE INVENTION

The present invention is directed to a method for the production of tungsten carbide powder product consisting primarily of WC (i.e., monotungsten carbide). The method includes heating a tungsten precursor compound in a gas composition that is effective to reduce and carburize the tungsten precursor compound and form WC. Preferably, the method is a continuous one-step method.

The tungsten precursor compound can be selected from many different tungsten-containing compounds. Examples include ammonium metatungstate, ammonium paratungstate, tungsten oxide and tungstic acid. For example, tungstic acid can be coated on a substrate material (e.g., WC particles) and then can be treated according to the present invention to convert the tungstic acid to tungsten carbide. A particularly preferred tungsten precursor compound according to the present invention is ammonium paratungstate (APT), such as APT having the formula (NH₄)₆W₁₂O₄₁. APT is particularly advantageous since the compound is readily available in high purity form. The method of the present invention advantageously permits the use of APT as a tungsten precursor compound without requiring any substantial modification of the APT, such as by milling or purifying.

The starting particle size of the tungsten precursor compound is not critical to the present invention. However, the starting particle size will be determinative of the particle size of the WC product powder and therefore can be selected accordingly. It may be desirable to mill the precursor compound so that the feed material has a smaller size.

The method of the present invention includes the step of heating the tungsten precursor compound in a reactor with control over the temperature and the gas composition during the process. One preferred type of reactor that can be utilized according to the present invention is a rotary kiln, such as a gas-fired rotary kiln. A preferred rotary kiln includes an elongated tube that is disposed on a horizontal axis wherein the tube can be adjusted to tilt several degrees from the horizontal axis. In this way, the tungsten precursor compound can be fed to the elevated end of the tube and can progress downwardly through the tube to control the residence time and heating rate of the feed. In addition, the elongated tube can be adapted to rotate about the horizontal axis to provide agitation of the tungsten precursor compound during the reaction, advantageously reducing agglomeration and enhancing the reaction kinetics. A rotary kiln can also include a feed screw disposed within the elongated tube wherein the feed screw rotates to move the tungsten precursor compound through a portion of the reactor. It will be appreciated that any one of these mechanisms or a combination of these mechanisms can be used to control the residence time of the feed in the reactor. By controlling the residence time and the heating zones, the heating rate can also be controlled. It is also preferred that the kiln is an indirectly heated kiln, that is, the heat is applied to the charge by external heating means such as electrical heating elements or combustion of hydrocarbon fuel.

One of the advantages of the present invention is that the process can be performed either as a batch process, semi-continuously or continuously in such a reactor. For example, a charge of tungsten precursor compound can be fed to the reactor and held within the reactor for a predetermined amount of time to achieve sufficient conversion of the tungsten to tungsten carbide as the feed moves from one end to the other. Reacted tungsten carbide can be continuously removed from the distal end of the elongated tube while a precursor compound is fed into the opposite end of the tube. This advantageously enables the continuous production of tungsten carbide from a tungsten precursor compound.

In a two-step process, the tungsten precursor compound is heated to a first temperature of at least about 450° C., preferably at least about 500° C., and more preferably at least about 540° C. This pretreating step occurs in a reducing gas composition that at least includes H₂. The gas is continuously supplied to the reactor and flows through the feed.

The precursor feed is further heated to carburize the feed and form WC. The carburization step includes heating the charge to a second temperature of at least about 700° C., more preferably at least about 800° C. and even more preferably at least about 820° C., such as from about 820° C. to about 880° C. The total reaction time can vary from about 1 to about 10 hours, and preferably is from about 2 to 4 hours.

The carburization reaction occurs under a carburizing gas composition that is able to carburize the feed. The carburizing gas should include at least one hydrocarbon species, such as methane (CH₄). The reaction that occurs during carburization can generally be written as:

WO₃+4CH₄→WC+3CO+8H₂

In one embodiment, the carburizing gas composition includes at least H₂, CH₄ and CO. According to a preferred embodiment of the present invention, the carburizing gas is natural gas. A typical natural gas composition includes methane (CH₄), ethane (C₂H₆) and propane (C₃H₈) along with other components such as carbon dioxide (CO₂) and nitrogen (N₂). Natural gas is preferred since it is readily available, however, it will be appreciated that other gas compositions can be used that include mixtures of methane and/or other hydrocarbon gases, hydrogen and carbon dioxide. The off-gas from the carburization reaction can advantageously be scrubbed and condensed to remove ammonia (NH₃) and water vapor. An afterburner can be utilized to combust residual hydrocarbons, if necessary. The scrubbed off-gas can then be recycled to the carburization step after adding sufficient make-up gas to conserve gas quantities.

According to a preferred embodiment of the present invention, the process is a continuous or semi-continuous process wherein a single gas precursor (e.g., natural gas) is used as both the reducing gas composition and the carburizing gas composition. That is, the reducing gas composition and the carburizing gas composition are derived from the same gas precursor. It will be appreciated that the actual gas composition that the feedstock is exposed to at different locations in the reactor will vary due to the reactions that are occurring. The process can then be operated in a continuous or semi-continuous mode in a reactor such as the rotary kiln described above. In this instance, the gas composition (e.g., natural gas) is continuously provided to the rotary kiln either in con-current or counter-current flow, with counter-current flow generally being preferred.

In accordance with this embodiment of the present invention, the precursor feed is fed to the reactor and is heated to the final reaction temperature in a well-controlled manner. Specifically, the feed is heated to the reaction temperature at a preferred rate of from about 3° C./min to about 9° C./min, more preferably from about 4° C./min to about 6° C./min. The preferred reaction temperature, as is discussed above, is at least about 700° C., more preferably at least about 800° C. and even more preferably at least about 820° C., such as from about 820° C. to about 880° C. The total time at the reaction temperature can vary from about 1 to about 10 hours, and preferably is from about 2 to 4 hours.

It will be appreciated that the equilibrium gas composition resulting from the reaction of the precursors with the carburizing gas will include other components. For example, the equilibrium gas composition will also include water (H₂O ) and carbon dioxide (CO₂). When APT is used as the tungsten precursor compound, the equilibrium gas composition can also include ammonia (NH₄).

The foregoing method advantageously provides a high conversion of tungsten in the tungsten precursor compound to WC. It is preferred that at least about 98 weight percent of the tungsten in the precursor compound is converted to WC. More preferably at least about 99 weight percent is converted and most preferably at least about 99.5 weight percent is converted. The WC is of high quality and preferably has an average crystallite size of not greater than about 20 nanometers, such as from about 5 to 20 nanometers. Average crystallite size can be estimated by applying the Scherrer equation to data obtained by x-ray diffraction analyses of the WC product.

The WC that is produced in accordance with the present invention has a stoichiometry that is very close to theoretical, which is 6.13 weight percent carbon. However, the WC product may have some excess carbon. In a preferred embodiment, the WC product exiting the reactor comprises not greater than about 0.8 weight percent excess carbon and more preferably not greater than about 0.4 weight percent excess carbon. Further, the method of the present invention minimizes other impurities in the tungsten carbide powder product. Impurities can be considered anything other than WC. The resulting tungsten carbide powder product preferably includes at least about 98 weight percent WC, more preferably at least about 99 weight percent WC, more preferably at least about 99.5 weight percent WC and even more preferably at least about 99.7 weight percent WC.

It may be desirable to reduce the carbon content to form a WC product that is closer to the stoichiometric value of 6.13 weight percent carbon. For example, excess free carbon can be detrimental to the sintering properties of the WC particles. Accordingly, the WC product can be treated to remove excess carbon. For example, excess carbon can be removed by reacting the WC product with a gas composition that selectively converts the free carbon to a gas such as carbon monoxide (CO).

For example, the WC product having an excess of free carbon can be fed to a reactor such as a fluidized bed reactor and fluidized with a gas composition of CO and CO₂ at an elevated temperature. At a temperature of about 825° C., the volume ratio of CO to CO₂ that is maintained in the reactor is preferably about 4:1. At lower temperatures the gas mixture can be richer in CO₂ while at higher temperatures it may be desirable to use an increased concentration of CO. The reaction that occurs can be written as:

C+CO₂→2CO

For each mole of excess carbon, one mole of CO₂ is consumed by the reaction. The excess carbon in the WC product feed can be calculated by measuring the actual carbon content and subtracting 6.13 weight percent. For example, 100 kg of WC product having 6.43 weight percent carbon has 26.9 moles of excess carbon and requires 26.9 moles of CO₂, which is equivalent to about 600 liters of CO₂ at standard temperature and pressure. Sufficient gas flow rates are maintained to fluidize the particles and to keep the ratio of CO to CO₂ at a minimum of about 5:1 in the off-gas, which can be continuously recycled. The presence of sufficient CO in the reaction atmosphere inhibits the reaction of WC with CO₂ to form W or W₂C. Alternatively, the tungsten carbide powder product can be similarly treated in a reactor under a gas composition including H₂ and CH₄.

The total reaction time will depend, for example, on the reaction temperature, which can vary from about 700° C. to about 1000° C., and the amount of excess of carbon that is being removed. The total reaction time can be from about 1 to 10 hours, with typical reaction times being on the order of 2 to 4 hours. The treatment to remove carbon can be carried out it a number of different reactors, including a rotary kiln or a fluidized bed reactor.

The average particle size of the tungsten carbide powder product is primarily a function of the particle size of the precursor feed. Therefore, reducing the average particle size of the feed material, for example the APT, can reduce the average particle size of the tungsten carbide powder product. APT will typically have an average particle size in the range of about 10 to 15 μm and the resulting tungsten carbide powder product will have a similar average particle size. The tungsten carbide powder product can be milled, such as in a jet-mill, to further reduce the average particle size. A jet mill is capable of reducing the average particle size to less than 1 μm, if desired.

After manufacture of the tungsten carbide powder product, the powder can be coated, such as by coating with cobalt in preparation for compacting and sintering into a final product. For example, the powder can be reacted with cobalt acetate to coat the particle with cobalt. According to one embodiment of the present invention, the tungsten carbide precursor (e.g., the APT) can be coated with a cobalt compound, such as cobalt acetate. The precursor is then reacted in accordance with the foregoing and the cobalt acetate reacts to form a thin cobalt coating on the tungsten carbide powder. This embodiment is particularly advantageous in that cobalt coated WC powder can be formed in a continuous, single-step process.

The present invention is further illustrated by the following examples.

### EXAMPLES

A tungsten precursor compound consisting of ammonium paratungstate (APT) was subjected to different pretreatment steps in conjunction with a carburization step. The results of Examples 1.1 through 1.4 are illustrated in Table I. For each of these examples, the carburization step included three hours of residence time at about 850° C. under a flowing gas mixture of H₂ (2.0 slpm), CO (1.0 slpm) and CH₄ (0.8 slpm). In each of Examples 1.1 to 1.4, the mass of the APT feed was about 135 grams.

TABLE I

| | Pretreatment Parameters | | | | | | |
|---|---|---|---|---|---|---|---|
| Example | Temperature | Solids Retention | Gas | Product Composition, % | | | |
| Number | (° C.) | Time (min) | Composition | WC | W₂C | W | WOₓ |
| 1.1 | 539 | 240 | 12 slpm H₂ | 99.6 | 0.2 | 0.1 | 0 |
| 1.2* | 539 | 60 | 12 slpm H₂ | 86.8 | 2.6 | 10.6 | 0 |
| 1.3* | 452 | 240 | 12 slpm H₂ | 92.5 | 1.6 | 5.9 | 0 |
| 1.4 | 543 | 240 | 8 slpm H₂ | 99.5 | 0.2 | 0.3 | 0 |

*comparative example

Example 1.1 illustrates that WC can be formed by holding the charge at about 539° C. for 4 hours and then carburizing the charge at about 850° C. for 3 hours. Comparing Example 1.2 to Example 1.1, a significantly reduced conversion of APT to WC was experienced when the solids residence time in the pretreatment step was decreased from four hours to one hour. Comparing Example 1.3 to Example 1.1, lowering the pretreatment temperature from 540° C. to 450° C. under otherwise identical conditions also resulted in decreased conversion efficiency. However, reducing the hydrogen gas flow rate from 12 slpm to 8 slpm had a negligible effect on the conversion efficiency, as is illustrated in Example 1.4. In Examples 1.1 and 1.4, 99.5 weight percent or more of the tungsten was converted to WC.

The standard pretreatment hydrogen gas was then replaced by the carburization gas mixture (H₂/CH₄/CO) to determine if the process could be implemented as a one-step, continuous or semi-continuous process. Thus, the pretreatment and carburization steps were performed in succession without removing or cooling the charge between stages.

In each of Examples 2.1 to 2.5 the carburization conditions were the same, namely three hours of solids residence time at 850° C. under a carburization gas flow of 2.0 slpm H₂, 1.0 slpm CO and 0.8 slpm CH₄. The mass of APT used as the feed material was about 135 grams.

TABLE II

| | Pretreatment Parameters | | | | | | |
|---|---|---|---|---|---|---|---|
| Example | Temperature | Solids Retention | Gas | Product Composition, % | | | |
| Number | ° C. | Time, min. | Composition | WC | W₂C | W | WOₓ |
| 2.1 | 546 | 240 | H₂/CO/CH₄ | 99.5 | 0.2 | 0.2 | 0 |
| 2.2* | — | 40 (to 850° C.) | H₂/CO/CH₄ | 80.6 | 0.9 | 18.5 | 0 |
| 2.3 | — | 240 (to 850° C.) | H₂/CO/CH₄ | 98.9 | 0.2 | 0.9 | 0 |
| 2.4* | 545 | 240 | H₂/CH₄ | 52.1 | 3.3 | 44.6 | 0 |
| 2.5 | — | 240 (to 850° C.) | H₂/CO/CH₄ | 99.3 | 0.1 | 0.6 | 0 |
| | | | (double H₂ flow) | | | | |

*Comparative example

In Example 2.1, the APT feed was held four hours at about 546° C. and then carburized. This resulted in 99.5 weight percent of the tungsten in the APT being converted to WC. Example 2.1 illustrates that the method can be operated using the same H₂/CH₄/CO gas composition for both the pretreatment and carburization steps.

In Example 2.2, the APT feed was heated to the carburization temperature of about 850° C. over a 40-minute time frame. As a result, the conversion of tungsten in the APT to WC was reduced to 80.6 weight percent.

In Example 2.3, the pretreatment was achieved by more slowly increasing the temperature of the charge to about 850° C. over a four-hour period (about 3.4° C. per minute) without an isothermal hold at a pretreatment temperature. 98.9 weight percent of the tungsten in the APT was converted to WC. Example 2.3 indicates that a separate pretreatment step with an isothermal hold is not necessary to achieve good conversion to WC if the heating rate is sufficiently low. Thus, the process of the present invention can be operated by gradually heating the charge at a controlled rate.

Example 2.4 was performed to determine the importance of including CO in the gas composition. Conditions were essentially identical to Example 2.1,except that CO was omitted from the gas composition. The gas flow rates were 2.0 slpm H₂ and 0.8 slpm CH₄. As a result, 52.1 weight percent of the tungsten in the APT was converted to WC. This poor conversion efficiency illustrates the importance of including CO in the gas composition in combination with H₂ and CH₄.

In Example 2.5, the effect of increasing the H₂ flow rate was examined. Example 2.5 is essentially identical to Example 2.3 except that the hydrogen flow rate was doubled. As a result, 99.3 weight percent of the tungsten in the APT was converted to WC.

Additional parameters in the process were then examined, as is illustrated in Table III.

TABLE III

| Example | | Product Composition, % | | | |
|---|---|---|---|---|---|
| Number | Variable | WC | W₂C | W | WOₓ |
| 3.1 | Reduction/carburization time reduced from 3.0 to 1.5 hours | 98.7 | 0.5 | 0.9 | 0 |
| 3.2 | Pretreatment time reduced from 4.0 to 2.5 hours | 99.3 | 0.1 | 0.6 | 0 |
| 3.3 | CO and CH₄ flow rates reduced to 0.3 slpm | 95.3 | 0.2 | 4.5 | 0 |
| 3.4 | Carburization temperature reduced from 850 to 750° C. | 99.0 | 0.9 | 0.1 | 0 |
| 3.5 | CO and CH₄ flow rates reduced to 0.5 slpm | 98.3 | 0.2 | 1.4 | 0 |
| 3.6 | 3 hour ramp, CO and CH₄ at 0.5 slpm, 2 hour carburization | 80.7 | 0.8 | 18.5 | 0 |
| 3.7 | 5 hour ramp, CO and CH₄ at 0.5 slpm, 2 hour carburization | 69.0 | 7.4 | 23.6 | 0 |
| 3.8 | Same as 3.6 but increased H₂ flow to 4 slpm | 94.6 | 1.2 | 4.2 | 0 |

The independent variable in Example 3.1 was the carburization time at about 850° C., which was reduced to 1.5 hours from the baseline value of 3.0 hours. All other conditions were duplicated from Example 2.1. 98.7 weight percent of the tungsten was converted to WC. Small amounts of tungsten metal and W₂C were observed. These results indicate that while conversion efficiency was slightly reduced, it is possible to reduce the solids residence time in the reduction/carburization step without significantly influencing the product composition.

In Example 3.2, the effect of lowering the pretreatment time to 2.5 hours from the standard baseline value of 4.0 hours was evaluated. Otherwise, the conditions were the same as Example 2.1. The reduced pretreatment time had only a small effect on the conversion efficiency. 99.3 weight percent of the tungsten in the feed was converted to WC. This indicates that a shorter pretreatment time is also feasible.

In Example 3.3, the CO flow rate was reduced from the standard 1.0 slpm to 0.3 slpm and the CH₄ flow rate was reduced from 0.8 slpm to 0.3 slpm. The experimental conditions were otherwise identical to those used in Example 2.1. The product analysis revealed that 95.3 percent of the tungsten in the feed was converted to WC.

In Example 3.4, the carburization temperature was reduced from 850° C. to 750° C. and 99.0 weight percent of the tungsten in the feed was converted to WC. Thus, the carburization step can be operated at temperatures at least as low as 750° C. without significantly affecting the product composition.

In Example 3.5, the CO and CH₄ flow rates in the inlet gas were reduced to 0.5 slpm from the standard 0.8 slpm. Hydrogen gas flow was held constant at 2.0 slpm. This resulted in 98.3 weight percent of the tungsten in the feed being converted to WC.

In Example 3.6, the improved results from Examples 3.3-3.5 were examined. Thus, a 3-hour ramp to 840° C. was utilized, the CO and CH₄ flow was reduced to 0.5 slpm each and carburization was carried out for about 2 hours. As a result, about 80.7 weight percent of the tungsten in the feed was converted to tungsten carbide. Thus, Example 3.7 increased the heating time to 5 hours. As a result, 69.0 weight percent of the tungsten in the feed material was converted to tungsten carbide.

In Example 3.8, Example 3.6 was followed but the hydrogen flow rate was increased to 4 slpm. This resulted in a significant increase in conversion wherein 94.6 weight percent of tungsten in the tungsten feed material was converted to tungsten carbide. This indicates that an increase in hydrogen partial pressure may permit the formation of tungsten carbide using short heating times.

Comparative Example 4.0 was also carried out to compare the present invention to the teachings of U.S. Pat. No. 5,919,428 by Gao et al. Specifically, the present inventors approximately duplicated Example 3 of Gao et al.

In this example, 135 grams of APT (1350 times the amount tested by Gao et al.) was placed into a kiln and was heated to about 700° C. over a period of 40 minutes (17.5° C./minute), where the APT charge was held for 90 minutes. The gas flow during the entire process consisted of 8 slpm H₂ and 4 slpm CO.

The resulting end product included 17 weight percent WC, 81 weight percent WO₂ and 2 weight percent W₂C.

In Example 5.0, an indirectly heated rotary kiln was used to manufacture the WC powder product to demonstrate the use of natural gas as a reduction and carburization gas composition, as well as the continuous, one-step production of high quality tungsten carbide powder product.

The rotary kiln included a stainless steel tube that was 12 feet long with a 6.5 inch internal diameter. The tube was housed in a 47.4 kilowatt resistance furnace having four independently controllable heating zones. A variable-speed motor and drive chain assembly was used to rotate the kiln. Four lifters, each constructed of ¼ inch diameter stainless steel rod were installed on the tubes internal circumference to facilitate turnover and mixing of the solid charge. A six-foot section of the tube was contained within the furnace.

In order to provide a total solids residence time in the six-foot hot zone of the reactor, the slope was adjusted to 0.06 inches per foot. The rotational speed was maintained at about 1.25 rpm to ensure that the solid feed is well reacted. The furnace zones were controlled such that the feed was heated to about 840° C. in about 2.5 hours (about 5.5° C./min) and was held at about 840° C. for about 2.5 hours.

Ammonium paratungstate was fed to the reactor at a rate of about 33 grams per minute and natural gas was fed to the reactor at a rate of about 12.2 slpm (standard liters per minute). The off-gas from the reaction was scrubbed and condensed to remove NH₃ and H₂O, after which the recycle gas included about 52 percent H₂, about 15 percent CO, about 25 percent CH₄ and the balance being mostly CO₂ and N₂.

The resulting tungsten carbide powder product included greater than about 99.7 weight percent WC and less than 0.2 weight percent W₂C. The average crystallite size of the WC was about 10 nanometers.

While various embodiments of the present invention have been described in detail, it is apparent that modifications and adaptations of those embodiments will occur to those skilled in the art. However, it is to be expressly understood that such modifications and adaptations are within the spirit and scope of the present invention.

What is claimed is:

1. A method for the production of tungsten carbide from a tungsten precursor compound, comprising the steps of:
a) pretreating said tungsten precursor compound in a reactor by heating said compound to a first temperature of at least about 450° C. in a reducing gas composition to form an intermediate tungsten product; and
b) carburizing said intermediate tungsten product in said reactor by heating said intermediate tungsten product to a second temperature of at least about 750° C. under a carburizing gas composition comprising at least a first hydrocarbon species to form a tungsten carbide product comprising at least about 98 weight percent WC.

2. A method as recited in claim 1, wherein said tungsten precursor compound comprises ammonium paratungstate.

3. A method as recited in claim 1, wherein said tungsten precursor compound consists essentially of ammonium paratungstate.

4. A method as recited in claim 1, wherein at least about 99 weight percent of tungsten in said tungsten precursor compound is converted to WC.

7. A method as recited in claim 1, wherein said hydrocarbon species is CH₄.

8. A method as recited in claim 1, wherein said reducing gas composition and said carburizing gas composition comprise CH₄.

9. A method as recited in claim 1, wherein said reducing gas composition is continuously supplied to said reactor during said pretreating step.

10. A method as recited in claim 1, wherein said carburizing gas composition is continuously supplied to said reactor during said carburizing step.

11. A method as recited in claim 1, wherein said reducing gas composition and said carburizing gas composition are derived from the same gas precursor.

12. A method as recited in claim 1, further comprising the step of agitating said tungsten precursor compound during said pretreating step.

13. A method as recited in claim 1, further comprising the step of agitating said intermediate product during said carburizing step.

14. A method as recited in claim 1, wherein said reactor is a rotary kiln.

15. A method as recited in claim 1, wherein said reactor is a rotary kiln comprising an elongated tube disposed on a horizontal axis and a feed screw disposed in said elongated tube adapted to rotate to move said feed through said elongated tube, wherein said average heating rate and said residence time is at least partly controlled by at least one of rotation of said feed screw and tilt from said horizontal axis.

16. A method as recited in claim 1, wherein said first temperature is at least about 500° C.

17. A method as recited in claim 1, wherein said second temperature is at least about 800° C.

18. A method as recited in claim 1, wherein said tungsten carbide product comprises WC having an average grain size of not greater than about 20 nanometers.

19. A method as recited in claim 1, wherein said said tungsten carbide product comprises WC having an average grain size of from about 5 to about 15 nanometers.

20. A method as recited in claim 1, wherein said method further comprises the step of recycling an off-gas from said pretreating and carburizing steps to form at least one of said first and second gas compositions.

21. A method for the production of tungsten carbide, comprising heating a tungsten precursor compound in a reactor at an average heating rate of from about 3° C./min to about 9° C./min in an gaseous atmosphere comprising at least a first hydrocarbon species to a reaction temperature of at least about 750° C. for a residence time sufficient to convert at least about 98 weight percent of tungsten in said tungsten precursor compound to WC.

22. A method as recited in claim 20, wherein said tungsten precursor compound comprises ammonium paratungstate.

23. A method as recited in claim 20, wherein said average heating rate is from about 4° C./min to about 6° C./min.

24. A method as recited in claim 20, wherein said reactor is a rotary kiln.

25. A method as recited in claim 20, wherein said reactor is a rotary kiln comprising an elongated tube disposed on a horizontal axis and a feed screw disposed in said elongated tube adapted to rotate to move said feed through said elongated tube, wherein said average heating rate and said residence time is at least partly controlled by at least one of rotation of said feed screw and tilt from said horizontal axis.

26. A method as recited in claim 20, wherein said method is a continuous process wherein said tungsten precursor compound is continuously fed to said reactor.

27. A method as recited in claim 20, wherein said reaction temperature is from about 800° C. to about 850° C.

28. A method as recited in claim 20, wherein said first hydrocarbon species is CH₄.

29. A method as recited in claim 20, wherein said gaseous atmosphere comprises natural gas.

30. A method as recited in claim 20, further comprising the step of treating said tungsten carbide powder product to remove excess carbon.

31. A method as recited in claim 20, further comprising the step of heating said tungsten carbide powder product in an atmosphere comprising CO and CO₂ to remove excess carbon.

32. A method as recited in claim 20, further comprising the step of heating said tungsten carbide powder product in a fluidized bed reactor under an atmosphere comprising CO and CO₂ to remove excess carbon.

33. A method for the production of a tungsten carbide powder product, comprising the steps of:
(a) providing a precursor feed comprising ammonium paratungstate;
(b) heating said precursor feed at a rate of from about 3° C./min to about 9° C./min in an gaseous atmosphere comprising CH₄;
(c) holding said precursor feed at a temperature of at least about 800° C. for a time sufficient to convert at least about 98 weight percent of tungsten in said precursor feed to WC; and
(d) cooling said tungsten carbide powder product.

34. A tungsten carbide powder product, comprising at least about 99.5 weight percent WC having an average crystallite size of not greater than about 20 nanometers.

35. A tungsten carbide powder product as recited in claim 33, wherein said average crystallite size is from about 5 to about 15 nanometers.

36. A tungsten carbide powder product as recited in claim 33, wherein said powder product comprises at least about 99.7 weight percent WC.
